(19) United States
(12) Patent Application Publication
(10) Pub. No.: US 2013/0262820 A1
(43) Pub. Date: Oct. 3, 2013

(54) EVENT LOGGER FOR JUST-IN-TIME STATIC TRANSLATION SYSTEM

(71) Applicants: Michael J. Rieschl, Roseville, MN (US); Thomas L. Nowatzki, Roseville, MN (US); James F. Merten, Roseville, MN (US); Nathan Zimmer, Hudson, WI (US)

(72) Inventors: Michael J. Rieschl, Roseville, MN (US); Thomas L. Nowatzki, Roseville, MN (US); James F. Merten, Roseville, MN (US); Nathan Zimmer, Hudson, WI (US)

(21) Appl. No.: 13/432,416

(22) Filed: Mar. 28, 2012

(51) Int. Cl. G06F 9/30

(52) U.S. Cl. 712/200; 712/E09.016

(57) ABSTRACT

Systems and methods for event logging in a just-in-time static translation system are disclosed. One method includes executing a workload in a computing system having a native instruction set architecture, the workload stored in one or more banks of non-native instructions. At least a portion of the workload is further included in one or more banks of native instructions and executing the workload comprises executing at least part of the workload from the one or more banks of native instructions. The method also includes determining an amount of time during execution of the workload in which the execution of the workload occurs from the one or more banks of native instructions. The method includes generating a log including performance statistics generated during execution of the workload, the performance statistics including the amount of time.

### TECHNICAL FIELD

The present application relates generally to methods and systems for just-in-time static translation for emulated computing environments. In particular, the present application relates to an event logger for a just-in-time static translation system.

### BACKGROUND

Many software applications, in particular those that require a large degree of data security and recoverability, are traditionally supported by mainframe data processing systems. Such software applications may include those associated with utility, transportation, finance, government, and military installations and infrastructures. Such applications are generally supported by CMOS based mainframe systems, because mainframes provide a large degree of data redundancy, enhanced data recoverability features, and sophisticated data security features. These mainframes implement proprietary instruction sets and architectures.

As “off-the-shelf” commodity data processing systems have increased in processing power, there has been movement towards using such systems to support industries that historically employed mainframes for their data processing needs. These computer systems may be used to update legacy data, which may include records from any of the aforementioned sensitive types of applications. This scenario presents several challenges.

First, as previously alluded to, the Operating Systems (OS's) that are generally available on commodity-type systems do not include the security and protection mechanisms needed to ensure that legacy data is adequately protected. For instance, when a commodity-type OS such as Windows or Linux experiences a critical fault, the system must generally be entirely rebooted. This involves reinitializing the memory and re-loading software constructs. As a result, in many cases, the operating environment, as well as much or all of the data that was resident in memory at the time of the fault, are lost. The system is therefore incapable of re-starting execution at the point of failure. This is unacceptable in applications that require very long times between system stops.

In addition, commodity OS's such as UNIX and Linux allow operators a large degree of freedom and flexibility to control and manage the system. For instance, a user within an UNIX environment may enter a command from a shell prompt that could delete a large amount of data stored on mass storage devices without the system either intervening or providing a warning message. Such actions may be unintentionally initiated by novice users who are not familiar with the often cryptic command shell and other user interfaces associated with these operating systems. In such situations, it is important to restrict access to the underlying infrastructure to ensure security and reliability.

In some cases, these concerns are addressed by executing a mainframe emulator upon a Linux operating system that is in turn executing upon commodity instruction processors. One example arrangement of such an emulated environment is illustrated in FIG. 1. In that arrangement, a server 10 includes a firmware layer 12, an interface layer 14, and an installation layer 16. The firmware layer 12 is communicatively connected to the interface layer 14, as is the installation layer 16. The firmware layer 12 and installation layer 16 can be used for booting the server 10, as well as starting one or more system services required to interact with hardware present in the server 10. The interface layer 14 generally represents an operating system maintaining the interface between hardware resources of the server 10, and includes an emulator 18, as well as hardware interface systems such as one or more I/O drivers 20, as well as a memory management subsystem 22 and a clock 24. The hardware interface systems 20, 22, and 24 generally are used by the interface layer 14 for generalized operation, and are made available to an emulated operating system 26 by the emulator 18 hosted within the interface layer 14. The emulated operating system 26 can in turn host execution or one or more applications 28a-x (in the illustration shown, 3 such applications 28a, 28b, and 28x are shown).

In operation, the server 10 cannot natively execute instructions of the emulated operating system 26 or applications 28a-x, as they are written using a different instruction set architecture that is incompatible with that provided by the server 10. Accordingly, the emulator 18 fetches one non-native (e.g., mainframe) instruction at a time from emulated main memory (via an interface to the memory management subsystem 22), and translates that instruction to one or more native instructions of the instruction set architecture supported by the server 10. The server 10 then executes the instruction using the native instruction set architecture.

Such systems have a number of drawbacks. For example, instruction-by-instruction dynamic translation can be resource intensive. Furthermore, for such translated code streams, it is necessary to ensure that the computing system is capable of performing each of the operations required by the software. This is especially the case when mainframe software is executed, because that type of software typically is required to have a higher degree of reliability and less tolerance for downtime. Addition of validation features to an instruction-by-instruction, dynamic translation system can be resource intensive.

In general three levels of debug and test are necessary to verify that the translation mechanism is working correctly, and to determine its performance: unit testing, product testing, and system testing. Such testing features typically must be accounted for in a system that executes or emulates a mainframe system, to ensure continued reliability. Inclusion of robust testing, debug, and performance monitoring features is often inconsistent with execution on a commodity system, which is typically not as robust as a mainframe system. As such, existing solutions do not provide a compelling solution for performance testing and validation of emulated systems, and in particular emulated mainframe systems. Nevertheless, such testing systems are necessary in many cases to determine performance advantages of various system configurations.

System testing for such emulated systems is further complicated because, when testing such systems for performance or validation reasons, it can be difficult to determine an appropriate time to add such performance testing features. Additionally, none of these existing testing arrangements provide for testing or benchmarking of comparative execution between static and dynamic translation within the same system, or would provide an integrated solution for testing advantages of at least partially static translation systems.

For these and other reasons, improvements are desirable.

### SUMMARY

In accordance with the following disclosure, the above and other issues are addressed by the following:

In a first aspect, a method includes executing a workload in a computing system having a native instruction set architecture, the workload stored in one or more banks of non-native instructions. At least a portion of the workload is further included in one or more banks of native instructions and executing the workload comprises executing at least part of the workload from the one or more banks of native instructions. The method also includes determining an amount of time during execution of the workload in which the execution of the workload occurs from the one or more banks of native instructions. The method includes generating a log including performance statistics generated during execution of the workload, the performance statistics including the amount of time.

In a second aspect, an event logger for a just-in-time static translation system is disclosed. The event logger includes program instructions executable on a computing system having a native instruction set architecture and upon which the just-in-time static translation system is implemented. The instructions cause that computing system to execute a workload stored in one or more banks of non-native instructions, wherein at least a portion of the workload is further included in one or more banks of native instructions and at least a part of the workload is capable of execution from the one or more banks of native instructions. The instructions also cause the computing system to determine an amount of time during execution of the workload in which the execution of the workload occurs from the one or more banks of native instructions, and generate a log including performance statistics generated during execution of the workload, the performance statistics including the amount of time.

In a third aspect, a computer-storage medium having computer-executable instructions stored thereon is disclosed. The computer-executable instructions include instructions written for execution on a computer having a native instruction set architecture. The computer-executable instructions, when executed, cause the computing system to perform a method including executing a workload on the computing system. The workload is stored in one or more banks of non-native instructions, and at least a portion of the workload is further included in one or more banks of native instructions and executing the workload comprises executing at least part of the workload from the one or more banks of native instructions. The method also includes detecting one or more bank transfer instructions during execution of the workload, thereby determining an amount of time during execution of the workload in which the execution of the workload occurs from a bank of native instructions selected from among the one or more banks of native instructions. The method further includes generating a log including performance statistics generated during execution of the workload, the performance statistics including the amount of time.

### BRIEF DESCRIPTION OF THE DRAWINGS

FIG. 1 illustrates a prior art computing system in which one or more non-native software programs can be emulated;

FIG. 2 illustrates a just-in-time static translation emulation system operable within a computing system, within which aspects of the present disclosure can be implemented according to a possible embodiment of the present disclosure;

FIG. 3 illustrates a logical arrangement of memory within a just-in-time static translation emulation system such as that illustrated in FIG. 2, according to an example embodiment;

FIG. 4A is an example execution flow illustrating execution differences between prior art and just-in-time static translation systems;

FIG. 4B is an execution flow illustrating an example of execution within a system implementing just-in-time static translation, according to an example embodiment of the present disclosure;

FIG. 5 is an example data diagram illustrating event logging in a just-in-time static translation environment, according to an example embodiment;

FIG. 6 is a flowchart of an example method and/or system for executing an example workload, such as a benchmark, in a just-in-time static translation environment, according to an example embodiment of the present disclosure;

FIG. 7 is a flowchart of an example method and/or system for event logging in a just-in-time static translation environment, according to an example embodiment of the present disclosure;

FIG. 8 is a flowchart of a method performing a bank transfer instruction in a just-in-time static translation system, according to an example embodiment of the present disclosure;

FIG. 9 is an example portion of an output text file that can be generated using the methods and systems for just-in-time static event logging, according to an example embodiment of the present disclosure; and

FIG. 10 illustrates an electronic computing device with which aspects of the just-in-time static translation emulation system can be implemented.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for event logging in a just-in-time static translation system. The methods and systems disclosed herein are particularly applicable in the context of execution of workloads, including known workloads such as benchmarks, on a system that emulates execution of a non-native system by executing from one or more banks of instructions that are native instructions, pretranslated from the non-native instructions that represent the workload. According to the various embodiments herein, a variety of types of information can be captured describing performance of a just-in-time static translation system on a particular workload. In some embodiments, known workloads, such as benchmarks, can be used to determine relative performance of a just-in-time static translation system as compared to a traditional static or dynamically translated emulation system, to determine comparative performance, or to otherwise identify possible areas for performance improvement.

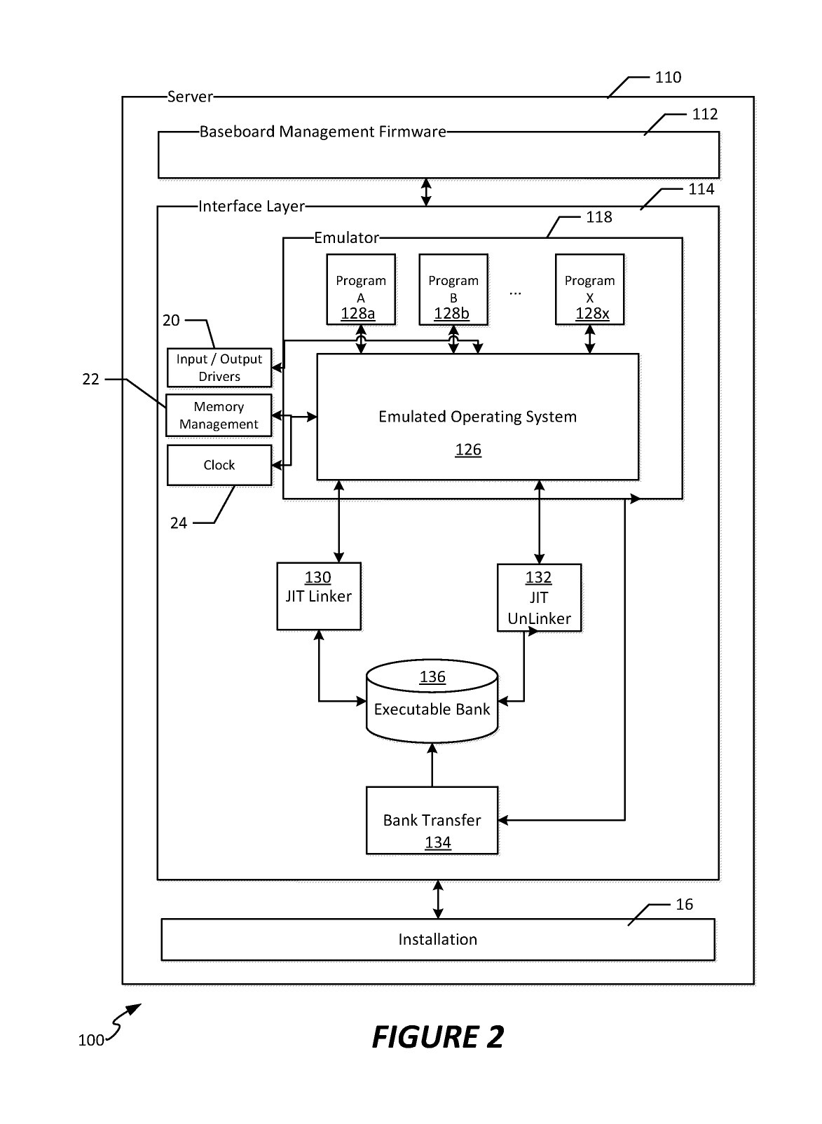

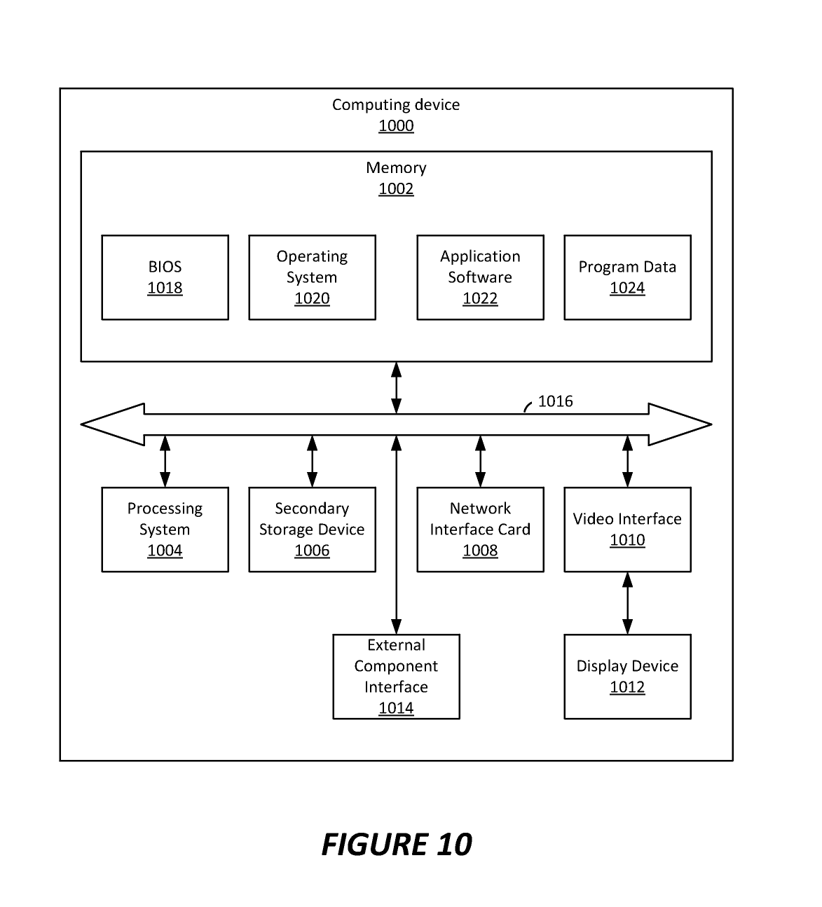

Referring now to FIG. 2, a just-in-time (“JIT”) static translation emulation system 100 is shown in which the event logging of the present disclosure can be implemented. In the embodiment shown, the system 100 is operable within a computing system, such as on a server 110. An example server is described in further detail below in conjunction with FIG. 10; however, in general the server corresponds to a multi-processor computing system having a commodity instruction set architecture. In some embodiments of the present disclosure, the server 110 operates using an Intel-based instruction set architecture (e.g., IA32, IA32-x64, IA64, etc.); however, other instruction set architectures could be used.

In the embodiment shown, the server 110 includes a firmware layer 112, an interface layer 114, and an installation layer 116. The firmware layer 112 and the installation layer 116 are each communicatively connected to the interface layer 114. As with other emulation systems, the firmware layer 112 and installation layer 116 can be used for booting the server 110, as well as starting one or more system services required to interact with hardware present in the server 110. The interface layer 114 generally represents an operating system maintaining the interface between hardware resources of the server 110. The interface layer 114 can be, in certain embodiments, an operating system compiled for execution on a native instruction set architecture, such as a Linux- or Unix-based operating system. In alternative embodiments, other operating systems could be used, such as a Windows operating system provided by Microsoft Corporation of Redmond, Wash.

In the embodiment shown, the interface layer 114 includes an emulator 118, as well as hardware interface systems such as one or more I/O drivers 120, as well as a memory management subsystem 122 and a clock 124. The hardware interface systems 120-124 generally are used by the interface layer 114 for generalized operation, and are made available to an emulated operating system 126 by the emulator 118 hosted within the interface layer 114. Any of a variety of emulated operating systems can be used, such that the emulated operating system is implemented using a non-native instruction set architecture. In one possible embodiment, the emulated operating system is the OS2200 operating system provided by Unisys Corporation of Blue Bell, Pa. Other emulated operating systems could be used as well, but generally refer to operating systems of mainframe systems.

The emulated operating system 126 can host execution or one or more applications 128a-x (in the illustration shown, 3 such applications 128a, 128b, and 128x are shown). The applications 128a-x are generally maintained in a memory managed by the emulated operating system 126 by separating that memory into memory banks In the context of the present disclosure, these memory banks are also referred to as non-native memory banks, or banks of non-native instructions. This means that the applications 128a-x defined by the instructions maintained in those banks are written for execution on a non-native instruction set architecture not directly executable by the server 110. Although the size of such memory banks may vary based on the emulated operating system used, in a possible embodiment each memory bank has a size of 262 k words. Other memory bank sizes may be used as well.

In contrast to prior art systems, the interface layer 114 as illustrated in this embodiment also includes a linker component 130, an unlinker component 132, and a bank transfer module 134, each of which are interfaced to one or more translated memory banks in a data store 136. The translated memory banks correspond to emulated, non-native memory banks managed by the emulated operating system 126, but are translated into native instructions, which can be directly executed on the server 110 without requiring further instruction-by-instruction translation.

The linker component 130 manages association of one or more of the translated memory banks in the data store 136 to the emulator 118, which selectively directs execution either (1) from a translated memory bank, natively on the server 110, or (2) based on instruction-by-instruction translation from a non-native memory bank defined by the emulated operating system 126, if no translated memory bank exists or is capable of being linked to the emulator 118.

The unlinker 132 disassociates translated memory banks from the emulator 118. For example, in certain embodiments, only a predetermined number of memory banks can be associated at once with the emulator, for example due to physical memory constraints of the server 110. In such circumstances, only a subset of the available translated memory banks in the data store 136 may be linked to the emulator 118 at once. When a maximum number of translated memory banks has been reached but operation of an application has transferred to an unlinked (but translated) memory bank, one of the currently linked memory banks is disassociated from the emulator 118 by the unlinker 132 (e.g., based on being a least recently used translated memory bank, or other analogous scheme). This will allow the linker 130 to associate the relevant unlinked translated memory bank with the emulator 118 for native execution on the server 110.

The bank transfer module 134 transfers memory banks of non-native instructions to the data store 136, where they can be accessed and translated by a translator component. Additional details regarding translation are provided below.

In use, when the emulator 118 fetches an instruction that transfers control from one bank to another a check is made to see if a translated version of that memory bank has been linked to the emulator 118 within the interface layer 114. If the bank has been linked, the emulator 118 will call the bank directly within the interface layer. The bank executes directly on the instruction processor associated with the server 110, and continues to execute within that environment until another bank transfer or an error exception occurs.

In certain embodiments, overall management of memory banks is provided by the emulated operating system 126, such that the emulated operating system defines one or more memory banks of non-native instructions forming an application to be executed; as needed, the emulated operating system can then trigger translation of the non-native instructions in a particular memory bank to native instructions. The emulated operating system 126 can, when the translated memory bank is formed, trigger operation of the linker 130 to link the translated memory bank to the emulator 118, which can direct execution to occur from the native instructions included in that linked, translated memory bank. As such, the loading, linking, and unlinking of memory banks is controlled by the emulated operating system 126. This provides the necessary reliability in that the emulated operating system controls memory bank management, as opposed to allowing translation at a lower level (e.g., by the emulator 118 or interface layer 114.

It is noted that, if a problem occurs during translation of a memory bank or native execution from that memory bank, operation can revert to execution from an emulated memory bank of non-native instructions, using traditional instruction-by-instruction translation. The translated memory bank can then be examined for errors. Furthermore, the emulated operating system 126 can generate hash values associated with each of the translated memory banks, such that a mismatched hash value may indicate an error or tampering with that translated memory bank, and would trigger retranslation of the non-native version of that memory bank. Additionally, by translating the memory banks to native instructions, those native instructions can be scheduled and executed using the interface layer 114 and instruction set architecture of the server 110. Accordingly, the particular instruction set architecture and organization of the processing units in the server 110 can be utilized, including registers, memory, out-of-order execution techniques, and other efficiencies that would otherwise be unavailable if instruction-by-instruction translation in an emulator were the only mechanism available. Furthermore, using the system 100 as illustrated, it is unnecessary to translate an entire environment to be emulated before execution; rather, only portions might be pretranslated, such as banks containing frequently-executed code. Additionally, in multiprocessor or multithreaded hardware systems, separate cores or threads could be used for execution of translated banks and translation of untranslated, non-native code to native instructions. Other advantages are realized through use of the system 100 as well.

It is noted that in some cases, execution of an instruction using the emulator 118 for instruction-by-instruction translation and execution can be more efficient than execution from a translated bank of instructions. This would be the case, for example, with instructions or instruction sequences that are complex, such that an exception that would occur at bank execution time would result in reduced efficiency of execution from the bank of instructions (i.e., in a non-predictable manner). For example, if an instruction causes an out-of-bounds memory reference, the emulator would better handle such an arrangement, as compared to using JIT execution, which would require roll-back to the pre-instruction state and hand-off of execution back to the emulator. Additionally, instructions that interface with the hardware or any host software or operating system software may involve inefficiencies if executed from pretranslated instruction banks In such cases, using performance and event logging can detect such circumstances, and would indicate to a developer of a JIT static translation system how to judiciously provide translated banks for execution to maximize performance of such a system.

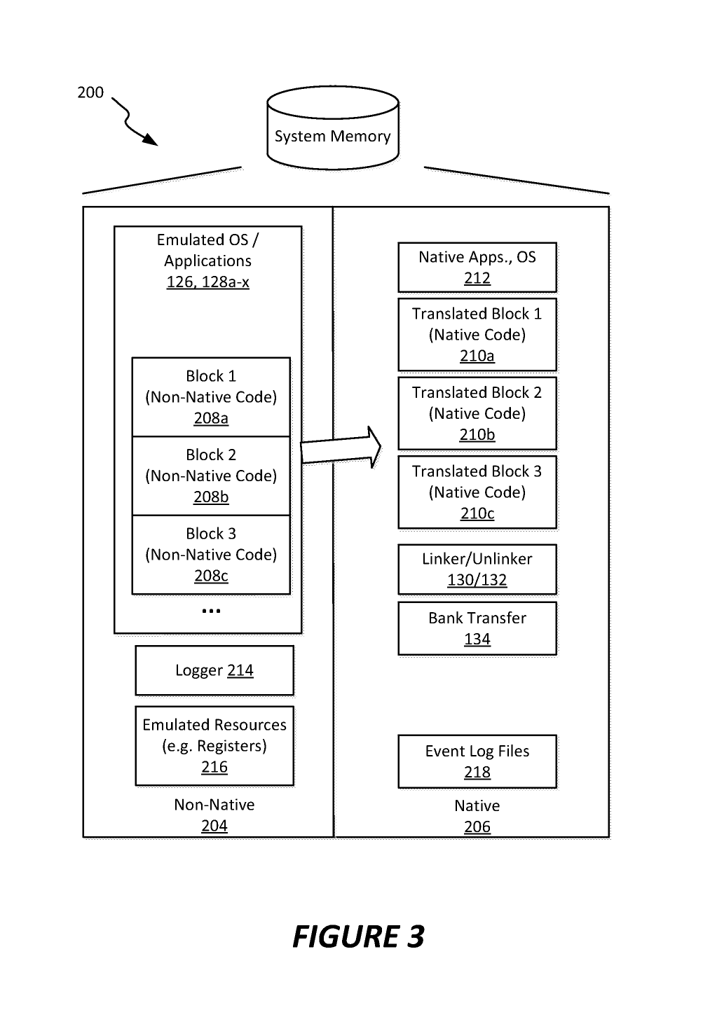

Referring now to FIG. 3, a logical arrangement of memory within a just-in-time static translation system such as the system 100 illustrated in FIG. 2 is shown, according to an example embodiment. The memory 200 as shown can be any of a variety of types of memory known in the art; in various embodiments, the memory 200 is a memory associated with a native computing system, such as described above in FIG. 2, and in further detail below in connection with FIG. 10.

In the embodiment shown, the memory 200 includes instructions and data stored according to both a native format (executable directly by hardware of a computing system), and a non-native format (e.g., requiring translation or emulation by software on the computing system). In the embodiment shown, the memory 200 has separate partitions, including a non-native partition 204 and a native partition 206. However, in various embodiments, separate partitioning of the memory may not be required.

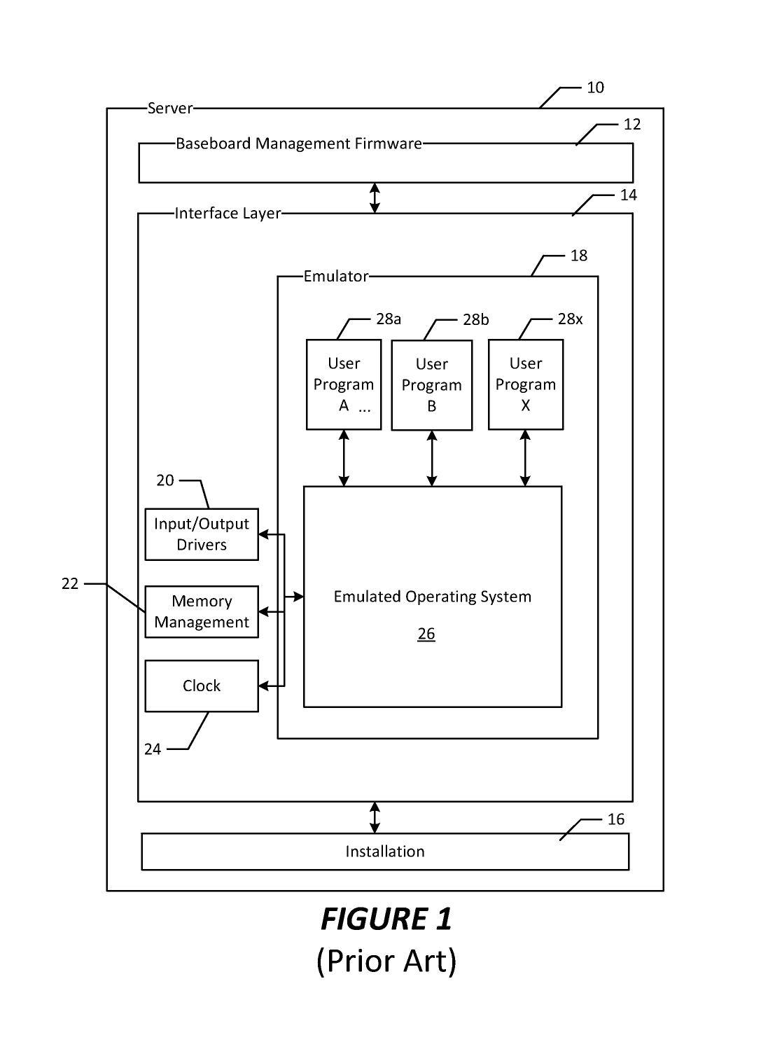

In the embodiment shown, the non-native partition 204 stores instructions and data that would be associated with or directly executable on a non-native system, such as the OS2200 system described above. In this embodiment, the non-native partition includes the emulated operating system 126 of FIG. 1, as well as one or more non-native applications 128a-x. In the context of the present disclosure, the one or more non-native applications 128a-x can include any of a variety of types of application workloads, such as productivity or financial suite applications, to modeling/database applications, to benchmark applications used to determine a relative performance of the JIT static translation system 100 itself. As illustrated, the emulated operating system 126 and non-native applications 128a-x are included in one or more banks 208 in memory. For simplicity, three banks 208a-c are illustrated in the examples set forth herein, however, it is noted that generally applications can reside in any size or number of banks It is noted that, in this embodiment, the banks 208a-c contain non-native instructions and data, such that execution of those banks requires pretranslation of the information contained therein.

In the embodiment shown, the native partition 206 includes a variety of native applications discussed above which are required to perform the JIT translation and/or bank management, including the linker and/or unlinker 130,132 and the bank transfer module 134. Operation of these modules is discussed generally above, and in further detail in copending U.S. patent application Ser. No. ______, filed ______, and entitled “JUST-IN-TIME STATIC TRANSLATION SYSTEM FOR EMULATED COMPUTING ENVIRONMENTS” (Docket No. RA5939), the disclosure of which is hereby incorporated by reference in its entirety.

The native partition 206 includes additional native instructions and data; in the embodiment shown, this includes native operating system and application data 212, as well as one or more translated banks 210. The translated banks 210 generally correspond to native translations of some or all of the non-native banks 208, for example as might be pretranslated and stored for execution by the JIT system 100 of FIG. 2. In the embodiment shown, three translated banks 210a-c are illustrated, representing translated versions of banks 208a-c. However, in alternative embodiments, fewer than all of the non-native banks 208 may be translated, or other numbers of banks could be translated as well.

The native operating system and application data 212 corresponds to software written for execution on a computing system according to a native instruction set architecture; in the example illustrated above in FIG. 2, this can include a Linux-based operating system and/or various other kernel or software systems.

In the embodiment shown, the non-native partition 204 also includes a logger component 214 which is configured to execute in conjunction with a JIT system such as the one illustrated in FIG. 2, and is configured to capture various system states when events occur within the JIT system. Various system states can trigger data capture, examples of which include initiating execution of a non-native application or workload, entering or exiting a translated, native bank that corresponds to a portion of that workload, entering or exiting an instruction-by-instruction translation and execution mode, or other events. In some embodiments, this can be based off of a bank entry or exit command as may be present in the non-native instruction set architecture (examples of which are discussed in further detail below). The logger component 214 can be configured to store statistics regarding operation of the JIT system on one or more workloads in existing, emulated system resources 216; for example an area of memory used to emulate a general register file of the non-native system. Upon completion of execution, data tracked in the system resources 216 can be exported to a log file 218 in the native partition 206, or other native file for review by a user. The log file 218 can take a number of forms; for example, it can be a text file, a formatted report, a spreadsheet, or other type of user-viewable or user-accessible document.

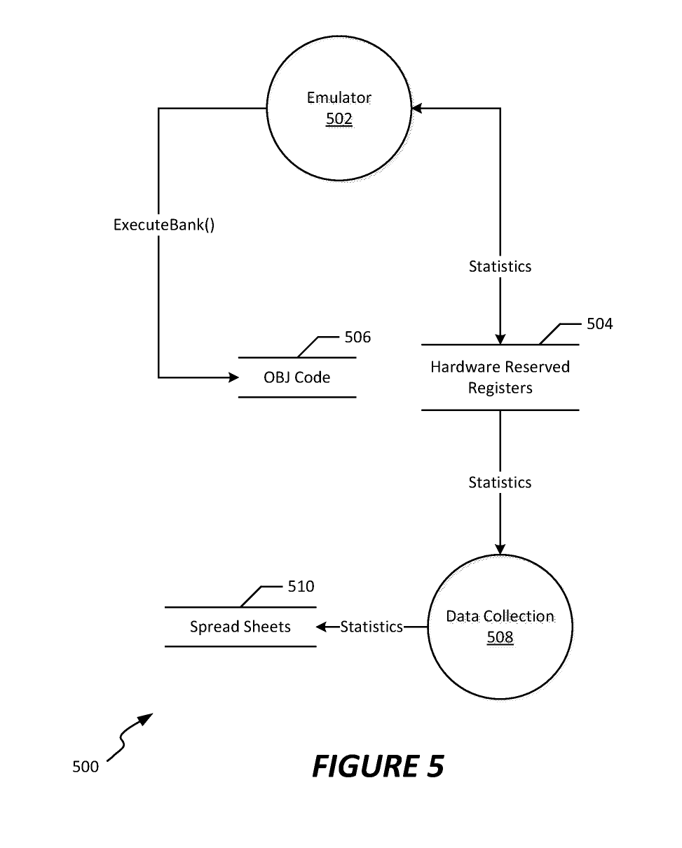

Overall, the data structures illustrated in FIG. 3 can be used by the JIT system 100 of FIG. 2 to manage and capture statistics regarding operation of the JIT system with minimal operational overhead which might degrade performance. Example logical data flows, and methods and systems of operation of event logging operations useable in connection with the JIT system 100 of FIG. 2, are described below in connection with FIGS. 5-9.

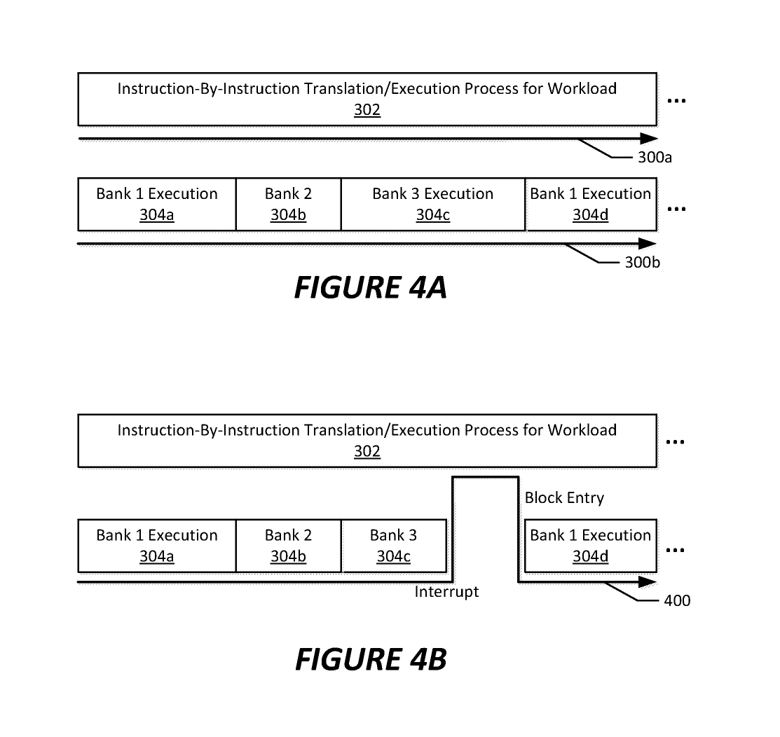

Referring now to FIGS. 4A-4B, example details of possible execution flows are illustrated for brief discussion, to provide context for the event logging operations discussed below. In FIG. 4A, example execution flows are illustrated, representing execution differences between prior art and just-in-time static translation systems. Specifically, FIG. 4A illustrates two code streams 300a-b. Code stream 300a represents execution of a workload 302 using solely instruction-by-instruction translation and execution. Conversely, code stream 300b represents execution of the same workload using, to a greatest extent possible, execution using translated banks of code. As illustrated, the code stream 300b corresponds to execution of a workload contained in memory banks 304a-c, with repeated execution of a first memory bank 304a. Arrows illustrate that in this example, instruction-by-instruction, or “emulated”, execution occurs without use of the translated memory banks, while use of the JIT system ideally executes code stream 300b, avoiding the requirement of such emulated execution.

The code streams 300a-b represent best case (in the example of stream 300b) and worst case (in the example of stream 300a) performance when executing a code stream, because executing only translated banks means that no translation overhead need occur during execution of the workload. In contrast, executing only untranslated, non-native code (as in the workload 302 of code stream 300a) represents a great deal of overhead, since each instruction must be serially fetched, decoded, translated to native code, and executed (thereby introducing a great deal of translation overhead).

FIG. 4B illustrates an execution flow 400, which represents a more typical or “real-world” scenario for execution of a workload using a JIT system such as system 100 of FIG. 2. In this example, the code streams 300a-b as executed generally involve executing all or a portion of some, but not all of the translated banks 304a-c. For example, in the example shown, execution of banks 304a-b completes, but execution of bank 304c is interrupted by a system interrupt or error within the bank. In such an instance, execution may continue once the interrupt is handled, but might execute based on instruction-by-instruction translation and execution from the source, non-native instructions in the code stream 300b. Additionally, it may be the case that a branch or other bank-exiting instruction could reference a location within a workload that remains untranslated; in such cases, instruction-by-instruction translation and execution may also occur. However, to the extent that execution flow causes a return to an area for which a translated native bank is available, the execution flow 400 can then return to that code bank, to execute native code for efficiency reasons.

As can be seen in FIG. 4B, in a typical arrangement a JIT system will execute partially from within pre-translated, native banks, but may also execute portions of a workload on an instruction-by-instruction basis. In the context of the present disclosure, various event logging capabilities are discussed which allow a user of such a system to detect the amount of time spent executing from each translated, native bank, and optionally an amount of time spent executing on an instruction-by-instruction basis, to determine relative performance benefits of the JIT system. Additionally, other metrics can be tracked as well, such as frequency of execution from particular banks, numbers of equivalent non-native instructions that are translated and executed, or other statistics.

Referring now to FIG. 5, an example data diagram 500 is shown, illustrating event logging in a just-in-time static translation environment. The data diagram 500 generally represents objects that execute as part of a JIT system and which have relevance to event logging, in the implementations discussed herein. In the embodiment shown, the data diagram 500 includes an emulator 502, which executes instructions according to the principles discussed above in connection with FIGS. 2-4. During execution, code included in the emulator 502 can be configured to trigger capture of one or more counters representing specific system states or occurrences within the emulator, such as a cycle identifier when a bank is entered, a number of executed non-native instructions, or other data. The emulator 502 can store this information in a set of general registers 504 available in the computing system on which the JIT system is implemented. The general registers 504 can be included, for example, in a memory of a computing system on which the JIT system is instantiated, for example as the non-native resources 214 of FIG. 3, above. The emulator 502 can, during execution, execute one or more translated banks (illustrated as ExecuteBank( ) function) to access object code 506 associated with a selected bank. That object code can include, for example all or a portion of a workload to be tested using the emulator. The emulator 502 will emit statistics to the general registers 504, which, once execution is completed, can be collected by a data collection component 508. The data collection component can derive one or more reports, illustrated in the example shown as spreadsheets 510, from the statistics obtained from the general registers. Alternatively, text files or other types of reports or log files could be generated. The data, once extracted from the general registers 504, can be manipulated and analyzed using the data collection component 508 to determine relative performance of the emulator 502, including various performance statistics.

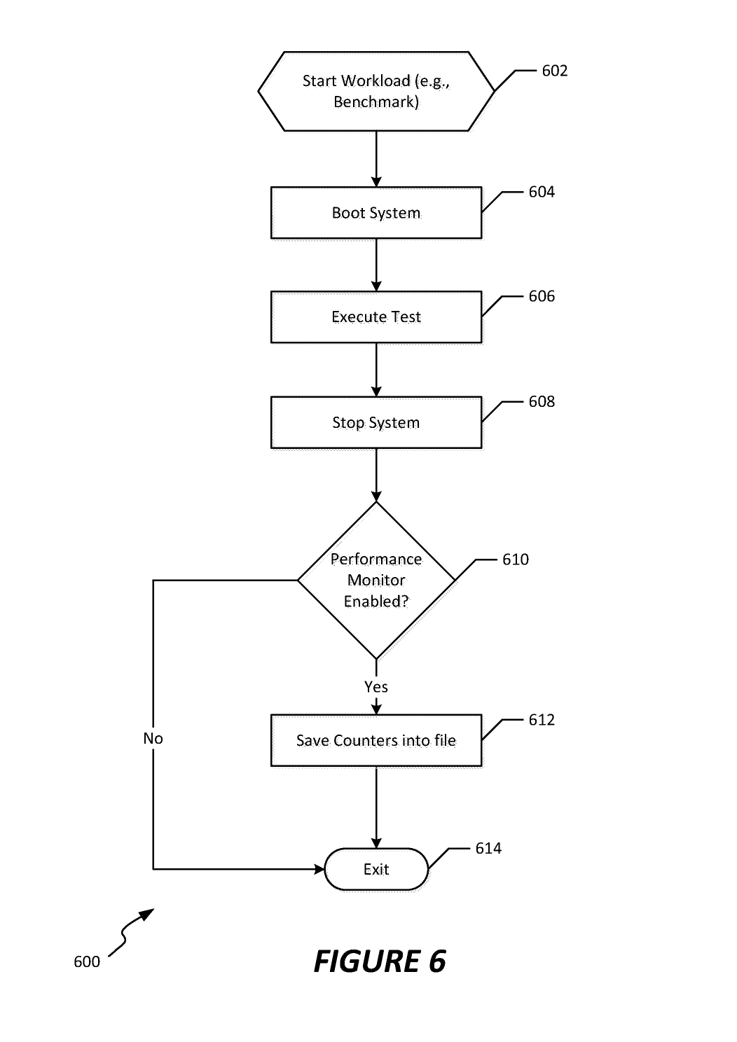

Referring now to FIGS. 6-8, example flowcharts are illustrated that represent example implementations of methods and systems for event logging within a JIT system, to accomplish the data extraction and logging discussed above in connection with FIGS. 3 and 5. The flowcharts illustrated in these figures can be implemented, for example, as processes within memory, or as software modules executing on a computing system, or a collection of computer executable instructions capable of execution on such a system.

Referring now to FIG. 6, a flowchart of an example method and/or system (shown as method 600) is shown for executing an example workload, such as a benchmark, in a just-in-time static translation environment. In the embodiment shown, the method 600 represents a general, top-level view of execution of a particular workload on a JIT system such as the one illustrated in FIG. 2. The workload, in the context of this figure, could represent a portion of an executable program, such as a benchmark, which is capable of execution on such a system, and for which at least a portion is stored in translated, native banks of instructions for execution by the JIT system.

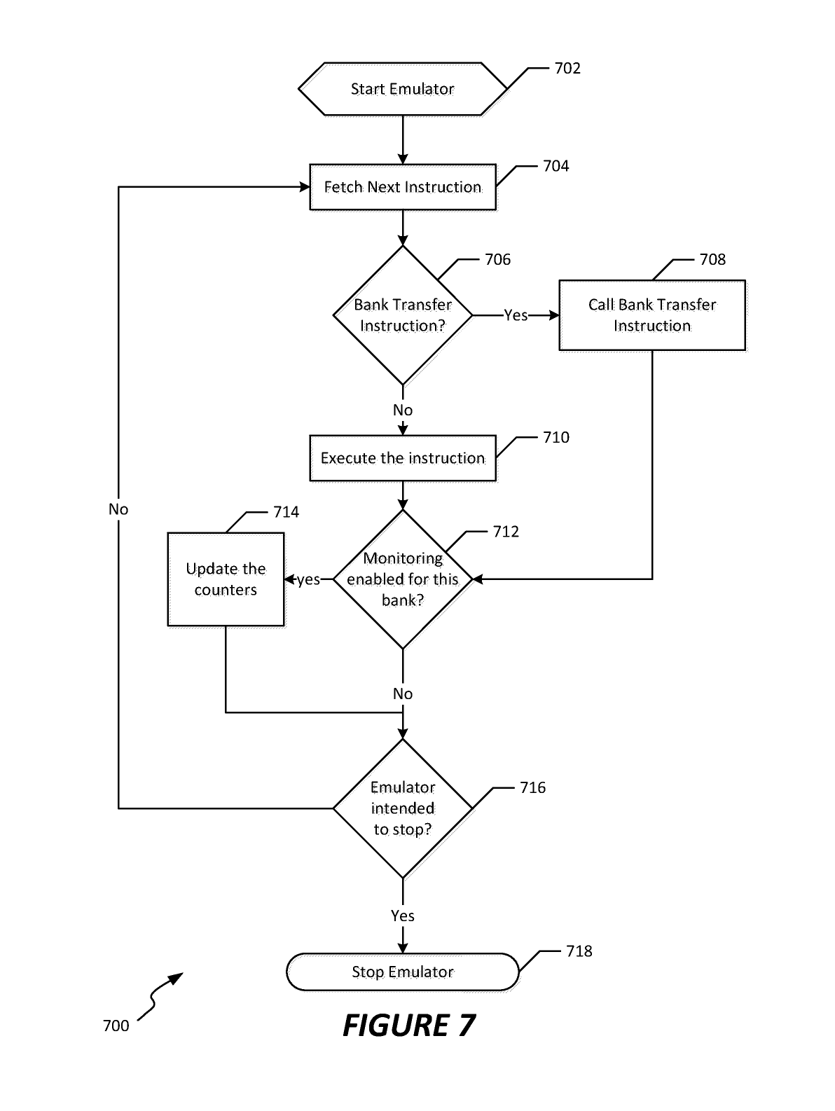

A start operation 602 generally corresponds to initialization of execution of the JIT system. A boot system operation 604 boots the system into a testing mode, for execution of one or more workloads with associated event logging enabled. The one or more workloads, which can include benchmarks or other application programs, are loaded into the non-native memory, and optionally one or more of the application programs is pre-translated into native banks, as previously discussed. A test execution operation 606 executes a test based on one or more of the loaded workloads. One example implementation of the test execution operation 606 is illustrated in FIG. 7, described below.

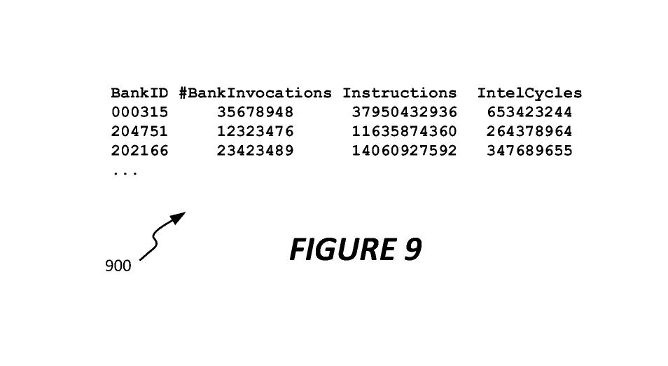

A stop operation 608 ends the test and associated counter gathering operations, to the extent applicable/enabled. A performance monitoring assessment operation 610 determines whether performance monitoring was enabled during execution of the workload. If performance monitoring was enabled, operational flow branches “YES” to a counters operation 612, which gathers counters from the non-native memory resources (e.g., the emulated register file 504 discussed above), and processes the gathered counters to generate one or more log files illustrating an execution profile associated with the workload. An example of a log file generated from a benchmark workflow is discussed below in conjunction with FIG. 9.

Following the counters operation 612, or alternatively upon determining that performance monitoring was not enabled as determined by the performance monitoring assessment operation 610 (and associated branch “NO”), operational flow proceeds to an exit operation 614. The exit operation 614 corresponds to completion of the workload and associated statistical gathering, and termination of operation of the JIT system.

Referring now to FIG. 7, a flowchart of an example method and/or system (shown as method 700) for event logging in a just-in-time static translation environment is shown. In particular, the method 700 illustrates operation of an emulator in the case event logging is enabled. The method 700 can represent, when applied to a particular workload, execution of the test operation 606 of FIG. 6, above.

In the embodiment shown, the method 700 is instantiated at a start operation 702, which starts operation of the emulator (e.g., emulator 502 of FIG. 5, generally corresponding to execution of a JIT system such as system 100 of FIG. 2). Once method 700 is instantiated, a next instruction operation 704 fetches a next instruction to be executed from a particular code stream to be executed on the computing system. A bank transfer assessment operation 706 determines whether the next fetched instruction is a bank transfer instruction. A bank transfer instruction corresponds to an instruction whose target for a next instruction to be executed is outside of a current bank in which the instruction executes. A bank transfer instruction can take many forms. In an example embodiment, the bank transfer assessment operation 706 detects the existence of any of a variety of different types of non-native instructions capable of resulting in a bank transfer. If the non-native system corresponds to a Unisys 2200 system, example bank transfer instructions can include a CALL instruction, a GOTO instruction, an LBJ instruction, an LIJ instruction, and an LDJ instruction. Other bank transfer instructions are possible as well.

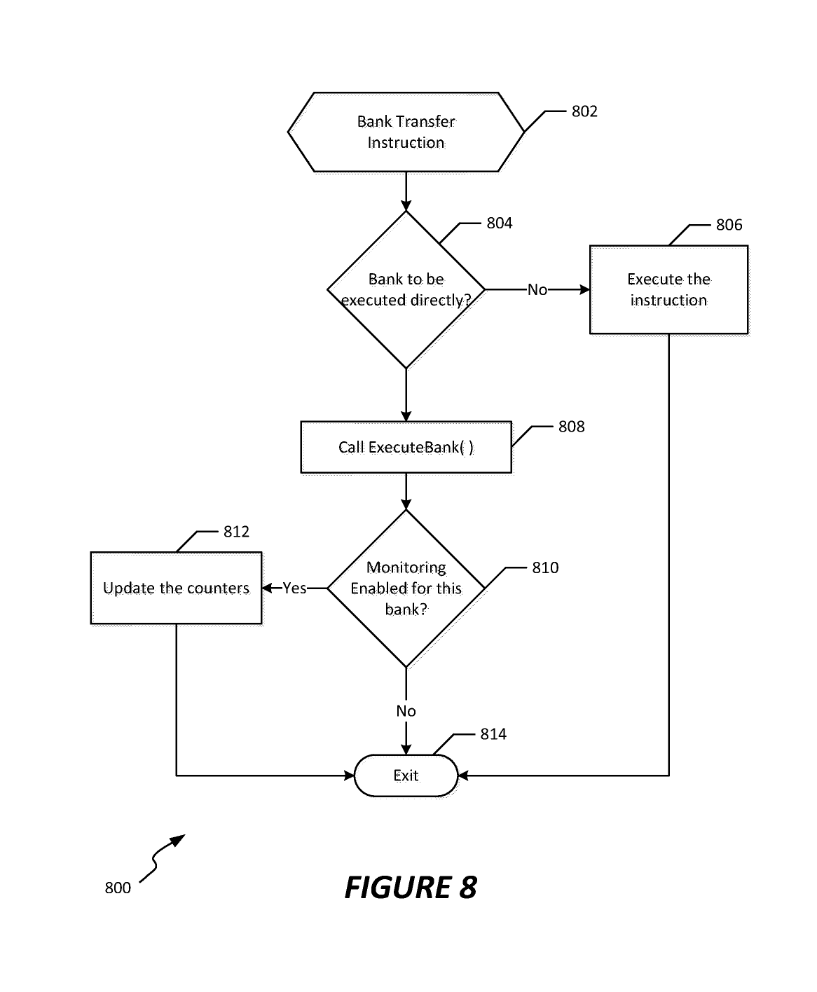

If the instruction fetched is a bank transfer instruction as determined by the bank transfer assessment operation 706, a bank transfer call occurs, and operational flow branches “YES” to a bank transfer operation 708, which is executed to change operational banks from which the system executes. The bank transfer operation 708 can include a variety of different types of operations; one example bank transfer operation is illustrated in further detail in FIG. 8, described below. If the instructions is not a bank transfer instruction, operational flow branches “NO” and an execution operation 710 is performed, resulting in standard execution of the instruction.

Regardless of whether the instruction was a bank transfer instruction or not, operational flow then proceeds to a performance monitoring operation 712, which assesses whether performance monitoring has been activated for the currently-active bank being executed. If performance monitoring has been activated, operational flow branches “YES” to a counters operation 714, which tracks and updates counters relating to current execution. For example, the counters operation 714 may increment the number of non-native instructions which have been performed in the bank, the elapsed time during which the bank has been executed, or other counter values. Following updating of the counters, or alternatively if performance monitoring was not activated (resulting in an operational flow branch “NO”), flow proceeds to a stop assessment operation 716. The stop assessment operation 716 determines whether the emulator is to be stopped. This may be because, for example, the emulator has received a command to stop, or has reached the end of a particular workflow, or other reasons.

If the emulator is not intended to stop, operational flow branches “NO” and returns to the next instruction operation 704, described above. However, if the emulator is intended to stop, operational flow branches “YES” to a stop operation 718.

Referring now to FIG. 8, a flowchart of a method and/or system (illustrated as method 800) of managing a bank transfer operation within a just-in-time static translation system is shown. The method 800 as shown corresponds to an example embodiment of a bank transfer operation 708 described in the method 700 of FIG. 7, above.

In the embodiment shown, the method 800 is instantiated at detection of a bank transfer instruction, depicted as a bank transfer instruction detection operation 802. A bank execution assessment operation 804 determines whether the bank is intended to be executed directly (i.e., from a native, translated bank), or whether the bank is intended to be emulated, using instruction-by-instruction fetching and emulated execution of non-native instructions. If the bank execution assessment operation 804 determines that a native bank should not be executed (e.g., is unavailable, erroneous, or otherwise should not be used), operational flow branches “NO” to an execution operation 806, which receives the instruction and emulates execution of the instruction based on a single-instruction decode and execution process. However, if the bank execution assessment operation 804 determines that a native bank is available and should be executed, operational flow branches “YES” to a bank execution operation 808 which calls the bank of native, translated instructions to be executed. For example, the bank execution operation 808 can include a call to an ExecuteBank( ) function, referencing the identity of the bank which is to be natively executed.

From the bank execution operation 808, a performance monitoring operation 810, which assesses whether performance monitoring has been activated for the currently-active bank being executed. If performance monitoring has been activated, operational flow branches “YES” to a counters operation 812, which tracks and updates counters relating to current execution. For example, the counters operation 812 may increment the number of non-native instructions which have been performed in the bank, the elapsed time during which the bank has been executed, or other counter values. Following updating of the counters, or alternatively if performance monitoring was not activated (resulting in an operational flow branch “NO”), flow proceeds to a stop assessment operation 814. Additionally, the stop assessment operation 814 is reached from the execution operation 806.

Referring to FIGS. 6-8 generally, it is noted that the methods described herein, and in particular at least operations of method 600, can be performed in a variety of orders, or on a variety of different types of workloads, such that the operations discussed herein could occur multiple times, or in different orders. For example, in one possible embodiment, the test execution operation 606 executes a test multiple times with various flags set or disabled to activate or deactivate features of a JIT system. For example, one example workload may include two banks of instructions, and the workload could be executed with various combinations of enabling and disabling particular banks for direct, native execution. In such a test, the workload is executed for every combination of banks turned on for direct execution and turned off for emulated, instruction-by-instruction emulation. Additionally, various counters operations 612 could generate separate data sets for each test, and all data could be analyzed between all cases and compared. The following table gives an example of two banks and the various benchmark executions that may be performed.

TABLE 1
Bank Enabling Permutations Example

| Test Description | Bank-A | Bank-B |
|---|---|---|
| Base Test | Emulated | Emulated |
| Bank-A called directly | Direct | Emulated |
| Bank-B called directly | Emulated | Direct |
| Banks A, B called directly | Direct | Direct |

The results output from the JIT system (and collected by data collection component 508 of FIG. 5), are then able to be compared between all executions and analyzed for performance improvements made by direct execution of static, translated native code. Additionally, statistics are capable of being kept and maintained for tracking performance improvements within purely emulated instructions (i.e., instructions fetched, translated, and executed on an instruction-by-instruction basis) because the emulator continues to implement performance improvements. Other types of test applications could be implemented using the methods and systems described herein.

Referring now to FIG. 9, an example portion of an output text file 900 that can be generated using the methods and systems for just-in-time static event logging, according to an example embodiment. The text file 900 represents only one example output file type that can be generated by a system implementing event logging in a JIT system. Other types of reports or logs, such as a spreadsheet, or a series of files or spreadsheets, could be generated as well. In the embodiment shown, the text file 900 represents a log tracking execution frequency and duration of execution within a number of translated, native banks in a JIT system.

In the embodiment shown, the text file includes an identifier of a plurality of different native banks, a number of times each of those banks was invoked during execution of a particular workflow, a total number of equivalent non-native instructions that were performed by those banks, as well as a total number of native cycles of a native processing unit that have elapsed. From this data, a variety of different types of additional information could optionally also be generated, such as a total amount of time elapsed during execution of each bank (e.g. cycles as adjusted by a known clock speed of the native processing unit), average instructions per clock within each bank, or other statistical information.

In alternative embodiments, other types of data could be captured using the event logging arrangements described herein. For example, cache hit rates, branch-mis-predictions, or other performance-affecting counters available on the native instruction set architecture could be captured. These may be useful, in connection with information about the particular non-native instructions executed and numbers of such non-native instructions executed, to determine reasons why the JIT translation execution either is or is not more efficiently-executed than the traditional, instruction-by-instruction emulation provided by emulator 118.

Additionally, as discussed above, various permutations of a single workload could be performed using different activated banks, to see relative performance differences of the overall system when one or more banks are either available or unavailable for native execution. Using such comparative tests, it is possible to determine and quantify performance advantages that are gained from pretranslation of banks, to allow a user to determine an optimal number and selection of banks to be pretranslated. Various other advantages relating to performance analysis are made possible by the event logging described herein as well.

Referring now to FIG. 10, a block diagram illustrating an example computing device 1000 is shown, which can be used to implement aspects of the present disclosure. In particular, the computing device 1000 can represent a server, such as server 110 of FIG. 2, and can be used to execute any of the methods or implement any of the systems discussed herein.

In the example of FIG. 10, the computing device 1000 includes a memory 1002, a processing system 1004, a secondary storage device 1006, a network interface card 1008, a video interface 1010, a display unit 1012, an external component interface 1014, and a communication medium 1016. The memory 1002 includes one or more computer storage media capable of storing data and/or instructions. In different embodiments, the memory 1002 is implemented in different ways. For example, the memory 1002 can be implemented using various types of computer storage media.

The processing system 1004 includes one or more processing units. A processing unit is a physical device or article of manufacture comprising one or more integrated circuits that selectively execute software instructions. In various embodiments, the processing system 1004 is implemented in various ways. For example, the processing system 1004 can be implemented as one or more processing cores. In another example, the processing system 1004 can include one or more separate microprocessors. In yet another example embodiment, the processing system 1004 can include an application-specific integrated circuit (ASIC) that provides specific functionality. In yet another example, the processing system 1004 provides specific functionality by using an ASIC and by executing computer-executable instructions.

The secondary storage device 1006 includes one or more computer storage media. The secondary storage device 1006 stores data and software instructions not directly accessible by the processing system 1004. In other words, the processing system 1004 performs an I/O operation to retrieve data and/or software instructions from the secondary storage device 1006. In various embodiments, the secondary storage device 1006 includes various types of computer storage media. For example, the secondary storage device 1006 can include one or more magnetic disks, magnetic tape drives, optical discs, solid state memory devices, and/or other types of computer storage media.

The network interface card 1008 enables the computing device 1000 to send data to and receive data from a communication network. In different embodiments, the network interface card 1008 is implemented in different ways. For example, the network interface card 1008 can be implemented as an Ethernet interface, a token-ring network interface, a fiber optic network interface, a wireless network interface (e.g., Wi-Fi, WiMax, etc.), or another type of network interface.

The video interface 1010 enables the computing device 1000 to output video information to the display unit 1012. The display unit 1012 can be various types of devices for displaying video information, such as a cathode-ray tube display, an LCD display panel, a plasma screen display panel, a touch-sensitive display panel, an LED screen, or a projector. The video interface 1010 can communicate with the display unit 1012 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1014 enables the computing device 1000 to communicate with external devices. For example, the external component interface 1014 can be a USB interface, a FireWire interface, a serial port interface, a parallel port interface, a PS/2 interface, and/or another type of interface that enables the computing device 1000 to communicate with external devices. In various embodiments, the external component interface 1014 enables the computing device 1000 to communicate with various external components, such as external storage devices, input devices, speakers, modems, media player docks, other computing devices, scanners, digital cameras, and fingerprint readers.

The communications medium 1016 facilitates communication among the hardware components of the computing device 1000. In the example of FIG. 10, the communications medium 1016 facilitates communication among the memory 1002, the processing system 1004, the secondary storage device 1006, the network interface card 1008, the video interface 1010, and the external component interface 1014. The communications medium 1016 can be implemented in various ways. For example, the communications medium 1016 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1002 stores various types of data and/or software instructions. For instance, in the example of FIG. 10, the memory 1002 stores a Basic Input/Output System (BIOS) 1018 and an operating system 1020. The BIOS 1018 includes a set of computer-executable instructions that, when executed by the processing system 1004, cause the computing device 1000 to boot up. The operating system 1020 includes a set of computer-executable instructions that, when executed by the processing system 1004, cause the computing device 1000 to provide an operating system that coordinates the activities and sharing of resources of the computing device 1000. Furthermore, the memory 1002 stores application software 1022. The application software 1022 includes computer-executable instructions, that when executed by the processing system 1004, cause the computing device 1000 to provide one or more applications. The memory 1002 also stores program data 1024. The program data 1024 is data used by programs that execute on the computing device 1000.

Although particular features are discussed herein as included within an electronic computing device 1000, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, DDR4 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally excludes transitory wired or wireless signals. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The above specification, examples and data provide a complete description of the manufacture and use of the composition of the invention. Since many embodiments of the invention can be made without departing from the spirit and scope of the invention, the invention resides in the claims hereinafter appended.

1. A method comprising:
executing a workload in a computing system having a native instruction set architecture, the workload stored in one or more banks of non-native instructions, wherein at least a portion of the workload is further included in one or more banks of native instructions and executing the workload comprises executing at least part of the workload from the one or more banks of native instructions;
determining an amount of time during execution of the workload in which the execution of the workload occurs from the one or more banks of native instructions; and
generating a log including performance statistics generated during execution of the workload, the performance statistics including the amount of time.

2. The method of claim 1, further comprising, prior to executing the workload, translating one or more of the banks of non-native instructions into the one or more banks of native instructions.

3. The method of claim 1, wherein executing the workload comprises executing at least part of the workload from the one or more banks of non-native instructions by translating instructions within the one or more banks of non-native instructions dynamically on an instruction-by-instruction basis.

4. The method of claim 3, further comprising comparing the amount of time to a second amount of time during execution of the workload in which execution of the workload occurs on the instruction-by-instruction basis.

5. The method of claim 1, wherein determining the amount of time includes capturing a time value at which execution of the workload enters a translated bank of native instructions.

6. The method of claim 5, wherein the time value is captured upon the occurrence of a bank transfer instruction.

7. The method of claim 6, wherein the bank transfer instruction is selected from a group of instructions consisting of:
a CALL instruction;
a GOTO instruction;
an LBJ instruction;
an LIJ instruction; and
an LDJ instruction.

8. The method of claim 1, further comprising determining an equivalent number of non-native instructions performed in the amount of time.

9. The method of claim 8, wherein generating a log of execution from the one or more banks comprises storing one or more statistics relating to execution of the workload, including the amount of time and the equivalent number of non-native instructions, in a text file.

10. The method of claim 1, wherein translating the one or more banks of non-native instructions occurs, for each bank, completely prior to execution of instructions within that bank.

11. The method of claim 1, wherein generating a log from the one or more banks includes logging a number of times in which each of the one or more banks of native instructions is executed.

12. The method of claim 1, wherein generating a log from the one or more banks during execution of the workload includes storing a total execution time of the workload.

13. The method of claim 1, further comprising comparing the total execution time of the workload to a second total execution time representing execution of the entire workload by translating and executing the workload on an instruction-by-instruction basis.

14. An event logger for a just-in-time static translation system, the event logger including program instructions which, when executed on a computing system having a native instruction set architecture and upon which the just-in-time static translation system is implemented, cause that computing system to:
execute a workload stored in one or more banks of non-native instructions, wherein at least a portion of the workload is further included in one or more banks of native instructions and at least a part of the workload is capable of execution from the one or more banks of native instructions;
determine an amount of time during execution of the workload in which the execution of the workload occurs from the one or more banks of native instructions; and
generate a log including performance statistics generated during execution of the workload, the performance statistics including the amount of time.

15. The event logger of claim 14, wherein the workload comprises a performance benchmark.

16. The event logger of claim 14, wherein the log comprises one or more spreadsheets.

17. The event logger of claim 14, wherein the program instructions define a data collection module.

18. A computer-storage medium having computer-executable instructions stored thereon, the computer-executable instructions including instructions written for execution on a computer having a native instruction set architecture, and wherein the computer-executable instructions, when executed, cause the computing system to perform a method comprising:
executing a workload on the computing system, the workload stored in one or more banks of non-native instructions, wherein at least a portion of the workload is further included in one or more banks of native instructions and executing the workload comprises executing at least part of the workload from the one or more banks of native instructions;
detecting one or more bank transfer instructions during execution of the workload, thereby determining an amount of time during execution of the workload in which the execution of the workload occurs from a bank of native instructions selected from among the one or more banks of native instructions; and
generating a log including performance statistics generated during execution of the workload, the performance statistics including the amount of time.

19. The computer-storage medium of claim 18, wherein the performance statistics include a count of occurrences in which the bank of native instructions is invoked.

20. The computer-storage medium of claim 19, wherein the amount of time comprises a count of cycles executed on the computing system.
